(19) United States
(12) Patent Application Publication
(10) Pub. No.: US 2025/0048289 A1
(43) Pub. Date: Feb. 6, 2025

(54) METHOD AND APPARATUS IN WIRELESS COMMUNICATION SYSTEM

(71) Applicant: SAMSUNG ELECTRONICS CO., LTD., Suwon-si (KR)

(72) Inventors: Pengru LI, Beijing (CN); Min WU, Beijing (CN); Feifei SUN, Beijing (CN)

(21) Appl. No.: 18/791,907

(22) Filed: Aug. 1, 2024

(30) Foreign Application Priority Data
Aug. 3, 2023 (CN) 202310975803.8

(51) Int. Cl. H04W 56/00; H04B 17/318; H04W 36/06; H04W 68/02

(52) U.S. Cl. CPC H04W 56/0015; H04B 17/328; H04W 36/06; H04W 68/02

(57) ABSTRACT

The disclosure relates to a 5G or 6G communication system for supporting a higher data transmission rate. The present disclosure provides a method and an apparatus in a wireless communication system, the method including: receiving configuration information for a first signal; performing a radio resource management (RRM) measurement based on the first signal in a case that a reference signal received power and/or a reference signal received quality of the first signal is determined to satisfy a first condition based on the configuration information; and performing the RRM measurement based on a synchronization signal and physical broadcast channel block (SSB) in a case that the reference signal received power and/or the reference signal received quality of the first signal is determined not to satisfy the first condition based on the configuration information.

### CROSS-REFERENCE TO RELATED APPLICATION

This application is based on and claims priority under 35 U.S.C. § 119 to Chinese Patent Application No. 202310975803.8 filed on Aug. 3, 2023, in the Chinese Intellectual Property Office, the disclosure of which is/are incorporated by reference herein in its/their entirety.

### BACKGROUND

### 1. Field

The present invention relates to the field of wireless communication technology, and more specifically, to a method and an apparatus in a wireless communication system.

### 2. Description of Related Art

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

### SUMMARY

The present disclosure relates to a method and an apparatus in a wireless communication system.

In one embodiment, a method performed by a user equipment (UE) in a wireless communication system is provided. The method includes receiving configuration information for a first signal; performing a radio resource management (RRM) measurement based on the first signal in a case that a reference signal received power and/or a reference signal received quality of the first signal is determined to satisfy a first condition based on the configuration information; and performing the RRM measurement based on a synchronization signal and physical broadcast channel block (SSB) in a case that the reference signal received power and/or the reference signal received quality of the first signal is determined not to satisfy the first condition based on the configuration information.

In another embodiment, a method performed by a base station in a wireless communication system is provided. The method includes transmitting, to a user equipment (UE), configuration information for a first signal, wherein the configuration information is used to determine whether a reference signal received power or a reference signal received quality of the first signal satisfies a first condition for performing a radio resource management (RRM) measurement based on the first signal; and receiving a result of the RRM measurement from the UE.

In yet another embodiment, a user equipment (UE) in a wireless communication system is provided. The UE includes: a transceiver; and a controller coupled with the transceiver and configured to: receive configuration information for a first signal, performing a radio resource management (RRM) measurement based on the first signal in a case that a reference signal received power and/or a reference signal received quality of the first signal is determined to satisfy a first condition based on the configuration information, and performing the RRM measurement based on a synchronization signal and physical broadcast channel block (SSB) in a case that the reference signal received power and/or the reference signal received quality of the first signal is determined not to satisfy the first condition based on the configuration information.

In yet another embodiment, a base station in a wireless communication system is provided. The base station includes: a transceiver; and a controller coupled with the transceiver and configured to: transmit, to a user equipment (UE), configuration information for a first signal, wherein the configuration information is used to determine whether a reference signal received power and/or a reference signal received quality of the first signal satisfies a first condition for performing a radio resource management (RRM) measurement based on the first signal, and receive a result of the RRM measurement from the UE.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF DRAWINGS

In order to illustrate the technical schemes of the embodiments of the present disclosure more clearly, the drawings of the embodiments of the present disclosure will be briefly introduced below. Apparently, the drawings described below only refer to some embodiments of the present disclosure, and do not limit the disclosure. In the drawings:

FIG. 1 illustrates a schematic diagram of an example wireless network according to some embodiments of the present disclosure;

FIGS. 2A and 2B illustrate example wireless transmission and reception paths according to some embodiments of the present disclosure;

FIG. 3A illustrates an example user equipment (UE) according to some embodiments of the present disclosure;

FIG. 3B illustrates an example gNB according to some embodiments of the present disclosure;

FIG. 4 illustrates a schematic diagram of a method performed by a user equipment (UE) in a wireless communication system according to various embodiments of the present disclosure;

FIG. 5A-5B illustrates a schematic diagram of a frequency domain position of a first signal according to various embodiments of the present disclosure;

FIG. 6A-6C illustrates a schematic diagram of a quasi co-location (QCL) relation of a first signal according to various embodiments of the present disclosure;

FIG. 7A-7C illustrates a schematic diagram of a UE monitoring a first signal according to various embodiments of the present disclosure;

FIG. 8A-8D illustrates a schematic diagram of a UE performing cell selection and/or cell reselection according to various embodiments of the present disclosure;

FIG. 9 illustrates a block diagram of a configuration of a UE according to various embodiments of the present disclosure; and

FIG. 10 illustrates a block diagram of a configuration of a base station according to various embodiments of the present disclosure.

### DETAILED DESCRIPTION

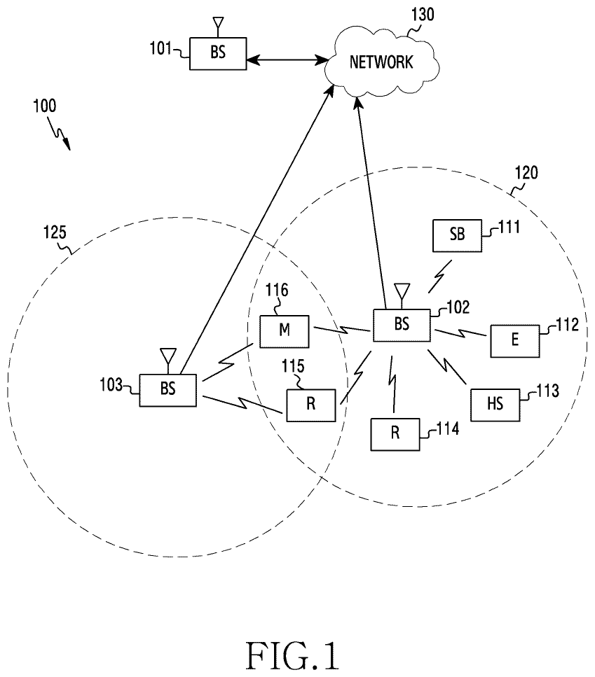

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

According to various embodiments of the present disclosure, there is provided a method performed by a user equipment (UE) in a wireless communication system, the method including: receiving configuration information for a first signal; performing a radio resource management (RRM) measurement based on the first signal in a case that a reference signal received power and/or a reference signal received quality of the first signal is determined to satisfy a first condition based on the configuration information; and performing the RRM measurement based on a synchronization signal and physical broadcast channel block (SSB) in a case that the reference signal received power and/or the reference signal received quality of the first signal is determined not to satisfy the first condition based on the configuration information.

In some implementations of the present disclosure, the method further includes: performing the RRM measurement based on the SSB in a case that a second condition is determined to be satisfied.

In some implementations of the present disclosure, the method further includes: performing the RRM measurement based on the first signal in a case that the second condition is determined not to be satisfied.

In some implementations of the present disclosure, the first condition includes at least one of: a difference between a reference cell selection RX level value for a serving cell of the UE and a cell selection RX level value calculated based on a reference signal received power of the first signal being less than or equal to a first threshold value, more than one consecutive reference signal received powers of the first signal being greater than or equal to a second threshold value, more than one consecutive reference signal received qualities of consecutive first signals being greater than or equal to a third threshold value, the reference signal received power of the first signal being greater than or equal to a fourth threshold value, the reference signal received quality of the first signal being greater than or equal to a fifth threshold value, the cell selection RX level value calculated based on the reference signal received power of the first signal being greater than or equal to a sixth threshold value, a cell selection quality value calculated based on the reference signal received quality of the first signal being greater than or equal to a seventh threshold value, a change range of one or more reference signal received powers of the first signal being less than or equal to an eighth threshold value, a change range of one or more reference signal received qualities of the first signal being less than or equal to a ninth threshold value, a change range of the cell selection RX level value calculated based on the reference signal received power of the first signal being less than or equal to a tenth threshold value, a change range of the cell selection quality value calculated based on the reference signal received quality of the first signal being less than or equal to an eleventh threshold value, a reference signal received power based on the SSB being greater than or equal to a twelfth threshold value, a reference signal received quality based on the SSB being greater than or equal to a thirteenth threshold value, a cell selection RX level value calculated based on the reference signal received power of the SSB being greater than or equal to a fourteenth threshold value, a cell selection quality value calculated based on the reference signal received quality of the SSB being greater than or equal to a fifteenth threshold value, a change range of the reference signal received power based on the SSB being less than or equal to a sixteenth threshold value, a change range of the reference signal received quality based on the SSB being less than or equal to a seventeenth threshold value, a change range of the cell selection RX level value calculated based on the reference signal received power of the SSB being less than or equal to an eighteenth threshold value, the cell selection quality value calculated based on the reference signal received quality of the SSB being less than or equal to a nineteenth threshold value.

In some implementations of the present disclosure, the second condition includes at least one of: the first signal being not received for more than a predefined or preconfigured time unit, a change range or a difference between a reference signal received power of a first signal of a neighboring cell of the UE and a reference signal received power of a first signal of a serving cell of the UE being greater than or equal to a twentieth threshold value, a change range or a difference between the reference signal received quality of the first signal of the neighboring cell of the UE and the reference signal received quality of the first signal of the serving cell being greater than or equal to a twenty-first threshold value, a change range of a cell selection RX level value calculated based on the reference signal received power of the first signal being greater than or equal to a twenty-second threshold value, a cell selection quality value calculated based on the reference signal received quality of the first signal being greater than or equal to a twenty-third threshold value, the UE not monitoring the first signal.

In some implementations of the present disclosure, the method further includes at least one of: performing cell selection or cell reselection in a case that a reference signal received power and/or a reference signal received quality of the first signal and/or the SSB satisfies a third condition; and performing the RRM measurement in a case that the reference signal received power and/or the reference signal received quality of the first signal and/or the SSB does not satisfy the third condition and/or satisfies a fourth condition.

In some implementations of the present disclosure, the method further includes determining whether to perform cell selection or cell reselection according to the reference signal received power and/or the reference signal received quality of the first signal and/or the SSB and one or more predefined or preconfigured threshold values, wherein determining whether to perform cell selection or cell reselection includes at least one of: in a case that the reference signal received power of the first signal is less than or equal to a first threshold value of the one or more predefined or preconfigured threshold values and/or the reference signal received quality is less than or equal to a second threshold value of the one or more predefined or preconfigured threshold values, or a cell selection RX level value calculated based on the reference signal received power of the first signal is less than or equal to the first threshold value of the one or more predefined or preconfigured threshold values and/or a cell selection quality value calculated based on the reference signal received quality of the first signal is less than or equal to the second threshold value of the one or more predefined or preconfigured threshold values, performing the cell selection and/or cell reselection; in a case that the reference signal received power of the first signal being greater than or equal to a third threshold value of the one or more predefined or preconfigured threshold values and/or the reference signal received quality of the first signal being greater than or equal to a fourth threshold value of the one or more predefined or preconfigured threshold values, or the cell selection RX level value calculated based on the reference signal received power of the first signal being greater than or equal to the third threshold value of the one or more predefined or preconfigured threshold values and/or the cell selection quality value calculated based on the reference signal received quality of the first signal being greater than or equal to the fourth threshold value of the one or more predefined or preconfigured threshold values, camping, by the UE, on a current cell; in a case that a reference signal received power of the SSB is less than or equal to a seventh threshold value of the one or more predefined or preconfigured threshold values and/or a reference signal received quality of the SSB is less than or equal to an eighth threshold value of the one or more predefined or preconfigured threshold values, or a cell selection RX level value calculated based on the reference signal received power of the SSB is less than or equal to the seventh threshold value of the one or more predefined or preconfigured threshold values and/or a cell selection quality value calculated based on the reference signal received quality of the SSB is less than or equal to the eighth threshold value of the one or more predefined or preconfigured threshold values, performing the cell selection and/or cell reselection; in a case that the reference signal received power of the SSB is greater than or equal to a fifth threshold value of the one or more predefined or preconfigured threshold values and/or the reference signal received quality is greater than or equal to a sixth threshold value of the one or more predefined or preconfigured threshold values, or a cell selection RX level value calculated based on the reference signal received power of the SSB is greater than or equal to the fifth threshold value of the one or more predefined or preconfigured threshold values and/or a cell selection quality value calculated based on the reference signal received quality of the SSB is greater than or equal to the sixth threshold value of the one or more predefined or preconfigured threshold values, camping, by the UE, on the current cell.

In some implementations of the present disclosure, the first signal is used to indicate whether to monitor a corresponding paging occasion (PO).

In some implementations of the present disclosure, the method further includes monitoring the first signal, wherein monitoring the first signal includes at least one of: monitoring the first signal within a predefined or preconfigured time unit before a start point of X POs or a predefined or preconfigured duration, monitoring the first signal within a predefined or preconfigured time unit before a start point of each PO.

In some implementations of the present disclosure, monitoring the first signal within a predefined or preconfigured time unit before a start point of each PO includes: when the UE detects the first signal, waking up to monitor subsequent Q POs, or until a UE-specific paging message is received.

In some implementations of the present disclosure, the method further includes: when the UE monitors the subsequent Q POs, not monitoring the first signal associated with the PO.

In some implementations of the present disclosure, the method further includes: if the UE is unable to monitor the first signal, monitoring, by the UE, each or associated paging occasion (PO).

In some implementations of the present disclosure, an end point where each or associated paging occasion (PO) is monitored includes a start of a next first signal or an end point of a paging time window.

In some implementations of the present disclosure, the configuration information further includes at least one of: a frequency domain position of the first signal, a quasi co-location (QCL) relation of the first signal, a power control offset of the first signal with respect to the SSB, an antenna port of the first signal.

In some implementations of the present disclosure, the frequency domain position of the first signal includes at least one of: being the same as a frequency domain position where a corresponding PO is located, being configured in a CORESET0, being configured in an initial downlink BWP for paging in the initial downlink BWP, being configured in a downlink BWP other than the initial downlink BWP for paging in the downlink BWP other than the initial downlink BWP.

In some implementations of the present disclosure, a method of determining the QCL relation of the first signal includes at least one of: assuming no QCL relation for the first signal if the configuration information does not include the QCL relation of the first signal, determining based on an SSB index configured in a higher layer parameter or RRC or SIB, determining based on the SSB index corresponding to a CORESET0, the first signal having the QCL relation with R SSBs, if it is provided or configured that R SSBs indexes are associated to one first signal, the first signal having the QCL relation with one SSB, if it is provided or configured that an SSB index is associated to T consecutive and/or valid first signals.

Preambles of S first signals with consecutive indexes associated with an SSB index n (n=0, . . . , R−1) within each first signal burst or occasion starting from a preamble index n*Y/R, if it is provided or configured that each first signal occasion/burst is associated to the preambles of the S first signal per SSB index, more than one first signals being included in a first signal burst or first signal transmission occasion, and the preambles of the S first signals with consecutive indexes associated with one SSB index within each first signal burst or occasion starting from a preamble index 0, if it is provided or configured that each first signal occasion/burst is associated to the preambles of the S first signals per SSB index, a preamble index of the first signal associated with an SSB index i (i=0, . . . , R−1) within each first signal burst or occasion is n*Y/R+i (n=0, . . . , R−1), if it is provided or configured that each first signal occasion/burst is associated to preambles of W first signals per SSB index.

In some implementations of the present disclosure, if the power control offset of the first signal with respect to the SSB is not provided or configured, a value of the offset is 0 dB.

In some implementations of the present disclosure, the power control offset of the first signal with respect to the SSB includes at least one of −3 dB, 0 dB, 3 dB, and 6 dB.

In some implementations of the present disclosure, a method for configuring the antenna port of the first signal includes at least one of: a same antenna port being used by all resource elements used for first signal transmission within a predefined or preconfigured time unit or an OFDM symbol duration of a predefined or preconfigured sequence length, if there is no explicit signaling indication of an antenna port configuration for the first signal, and/or if only one tracking reference signal (TRS) or low power synchronization signal (LP-SS) or SSB port is configured, a same antenna port being used by transmissions of time units where all first signals are located, if there is no explicit signaling indication of the antenna port configuration for the first signal, and/or if more than one TRS or LP-SS or SSB ports are configured by a base station, a same antenna port being used in T consecutive time units starting from the first time unit for the first signal transmission, wherein an association relation of the first signal with the more than one configured TRS or LP-SS or SSB ports is determined by the QCL relation of the first signal, if the first signal is configured with only one antenna port, a same antenna port being used by the transmissions of the time units where all first signals are located, if the first signal is configured with more than one antenna ports, a same antenna port being used in T consecutive time units starting from the first time unit for the first signal transmission, wherein the association relation of the first signal with the more than one configured TRS or LP-SS or SSB ports is determined by the QCL relation of the first signal.

According to various embodiments of the present disclosure, there is provided a method performed by a base station in a wireless communication system, the method including: transmitting, to a user equipment (UE), configuration information for a first signal, wherein the configuration information is used to determine whether a reference signal received power and/or a reference signal received quality of the first signal satisfies a first condition for performing a radio resource management (RRM) measurement based on the first signal; and receiving a result of the RRM measurement from the UE.

According to various embodiments of the present disclosure, there is provided a user equipment (UE) including: a transceiver configured to transmit and receive signals; and a controller coupled with the transceiver and configured to perform the aforementioned methods.

According to various embodiments of the present disclosure, there is provided a base station including: a transceiver configured to transmit and receive signals; and a controller coupled with the transceiver and configured to perform the aforementioned methods.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. gNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

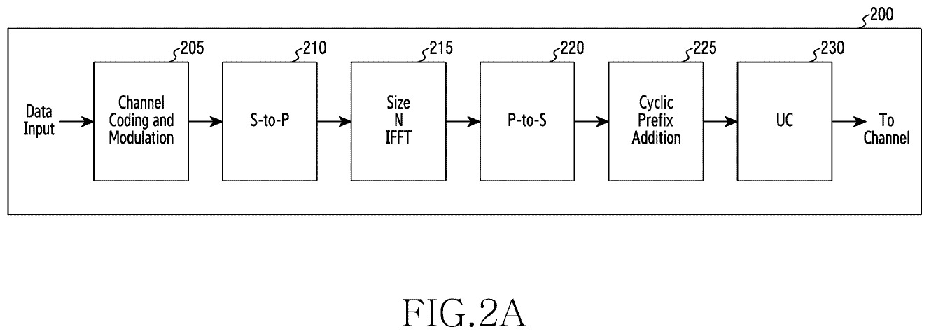

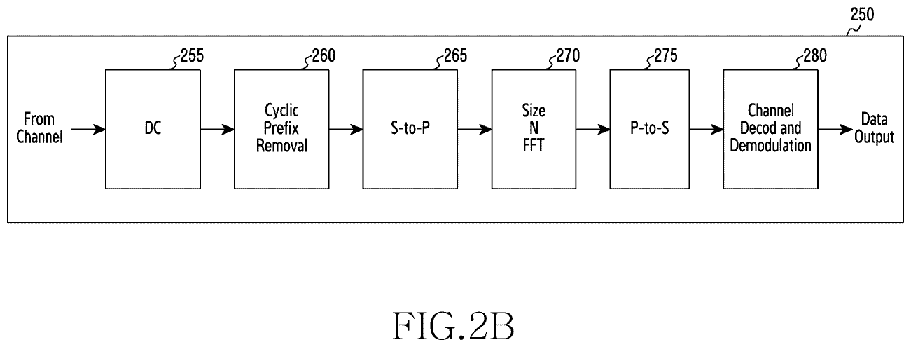

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

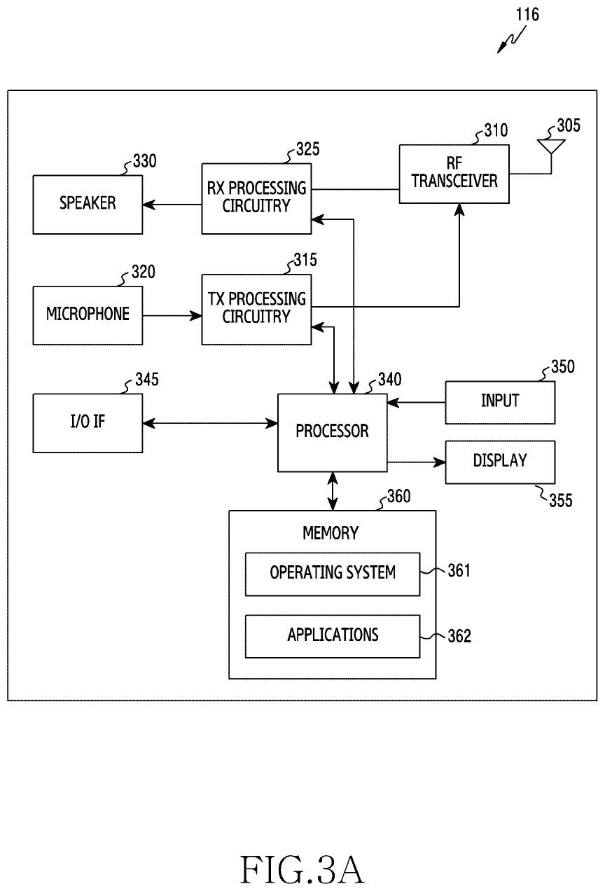

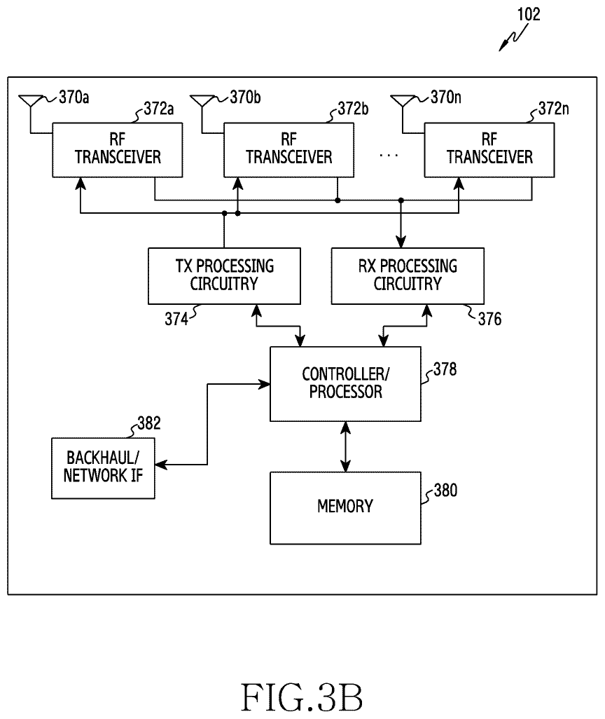

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

A time domain unit (also referred to as a time unit) in the present application may be: an OFDM symbol, an OFDM symbol group (consisting of more than one OFDM symbols), a slot, a slot group (consisting of more than one slots), a subframe, a subframe group (consisting of more than one subframes), a system frame, a system frame group (consisting of more than one system frames); also an absolute time unit, such as 1 millisecond, 1 second, etc.; and the time unit may also be a combination of multiple granularities, e.g., N1 slots plus N2 OFDM symbols.

A frequency domain unit (also referred to as frequency unit) in the present application may be: a subcarrier, a subcarrier group (consisting of more than one subcarriers), a resource block (RB) (which may also be referred to as a physical resource block (PRB)), a resource block group (consisting of more than one RBs), a bandwidth part (BWP), a bandwidth part group (consisting of more than one BWPs), a band/carrier, a band group/carrier group; also an absolute frequency domain unit, such as 1 hertz, 1 kilohertz, etc.; and the frequency domain unit may also be a combination of multiple granularities, e.g., M1 PRBs plus M2 subcarriers.

The exemplary embodiments of the present disclosure are further described below in conjunction with the accompanying drawings.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

The transmission links of a wireless communication system mainly include downlink communication links from a 5G New Radio (NR) gNB to a User Equipment (UE), uplink communication links from a UE to a network, and sidelink communication links from a UE to a UE.

In a wireless communication system, e.g. in a current wireless communication system, in order to reduce energy consumption at the terminal side, a discontinuous reception (DRX) mechanism is introduced so that the UE may be in a sleep state most of the time, and is only required to be periodically awakened to monitor a paging occasion (PO). Within one DRX cycle, the UE is awakened to monitor the PO only in a DRX ON duration, after monitoring a PDCCH scrambled by a P-RNTI, the UE continues to read the paged terminal flag in the paging message, if the read terminal flag is the same as the own flag, the UE further reads the paging message, otherwise, the UE discards the paging message. In the above procedure, in order to further reduce the energy consumption of the UE, a Paging early indication (PEI) signal is introduced to indicate whether the UE needs to monitor the corresponding PO. If the system information provides the PEI configuration, the UE monitors the PEI occasion once per DRX cycle, if the UE detects the PEI indication and the PEI indicates the UE to monitor the associated PO, the UE shall be awakened to monitor the PO at the next PO; otherwise, the UE is not required to be awakened to monitor the PO.

In order to determine whether the UE can camp on a non-serving cell, the UE performs synchronization signal (SS) and physical broadcast channel (PBCH) block (SSB) based RRM measurements, and if the SSB based RRM measurements satisfy cell selection and/or cell reselection principles, the UE performs cell selection and/or cell reselection. If a cell selection RX level value and/or a cell selection quality value calculated by results of the SSB based RRM measurements within a predefined or preconfigured duration of a non-serving cell is greater than a predefined or preconfigured threshold value, the UE may camp on the current cell. If a cell selection RX level value and/or a cell selection quality value calculated by the results of the SSB based RRM measurements within a predefined or preconfigured duration of more than one non-serving cells is greater than a predefined or preconfigured threshold value, the UE selects a cell on the highest priority frequency that satisfies the criteria.

In some use cases (e.g., Internet of Things devices and/or wearable devices) where low energy consumption of the UE is more stringent, in order to further prolong the battery life of the UE, a new low power consumption synchronization signal is designed for performing RRM measurements, and thus, improvements to the RRM measurement procedure are needed.

Optionally, the new low power consumption synchronization signal may also be used to wake up the UE. Further, there is also a need to improve the procedure of configuring, monitoring of the new low power consumption synchronization signal.

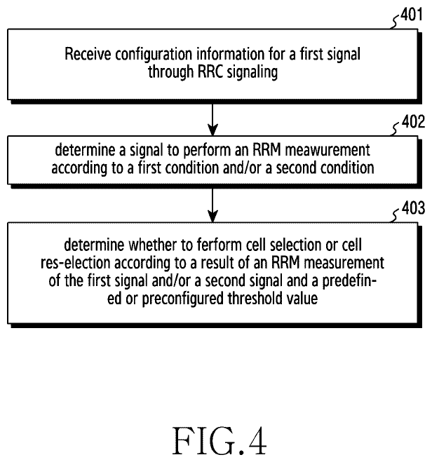

FIG. 4 illustrates a schematic diagram of a method 400 performed by a user equipment (UE) in a communication system according to an embodiment of the present disclosure. As shown in FIG. 4, the method 400 includes: 401: receiving configuration information for a first signal, and optionally, receiving the configuration information for the first signal through RRC signaling, 402: performing a radio resource management (RRM) measurement based on the first signal in a case that a reference signal received power and/or a reference signal received quality of the first signal is determined to satisfy a first condition based on the configuration information, and optionally, determining a signal to perform the RRM measurement according to the first condition and/or a second condition, and 403: performing the RRM measurement based on a synchronization signal and physical broadcast channel block (SSB) in a case that the reference signal received power and/or the reference signal received quality of the first signal is determined not to satisfy the first condition based on the configuration information, and optionally, determining whether to perform the cell selection or cell reselection according to a result of an RRM measurement of the first signal and/or a second signal and a predefined or preconfigured threshold value.

Specifically, in the present invention, a method and a device for configuring and transmitting a low power consumption synchronization signal will be described. In an embodiment in the present invention, a method for determining a configuration of a first signal, a monitoring method, and a method for a radio resource management (RRM) measurement will be introduced. The first signal includes at least one of: a Low Power Wake Up Signal (LPWUS), a Low Power synchronization signal (LP-SS), an SSB, a Primary Synchronization Signal (PSS), a Secondary Synchronization Signal (SSS), a PBCH Demodulation Reference Signal (DMRS), a Tracking Reference Signal (TRS). In the embodiment, the first signal is used for exemplary purposes, and the introduced methods can also be used for configuration and transmission of other signals.

A receiver of the UE contains two modules, one is a Main Radio (MR) for receiving regular signals/channels transmitted by a base station and the other is a Lower Power Wake Up Receiver (LR) for receiving the first signal transmitted by the base station, the reason for the reception of the first signal using the dedicated module is that the first signal is a waveform further based on Amplitude Shift Keying (ASK) modulation and/or Frequency Shift Keying (FSK) modulation based on Orthogonal Frequency Division Multiplexing (OFDM) waveform using the existing NR system, and the LR can receive or monitor the first signal with extremely low power and perform the RRM measurement. Optionally, the first signal may also be used to wake up the UE, i.e. once the UE monitors the first signal, the LR may trigger the MR to transition from dormant to active so that certain operations may be performed. Optionally, on-off keying (OOK) modulation is a special case of amplitude shift keying (ASK) modulation.

Configuration of First Signal Resource is provided.

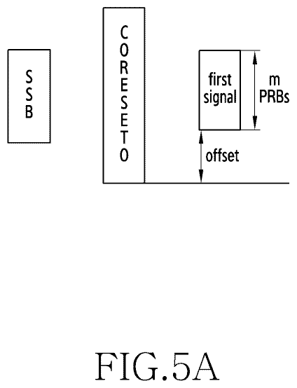

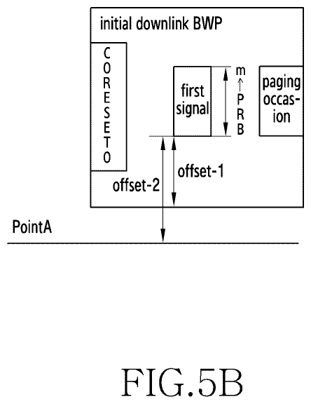

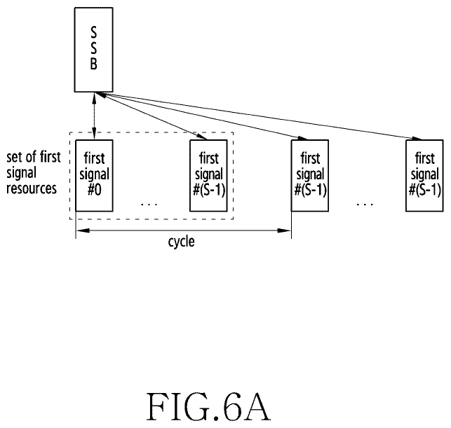

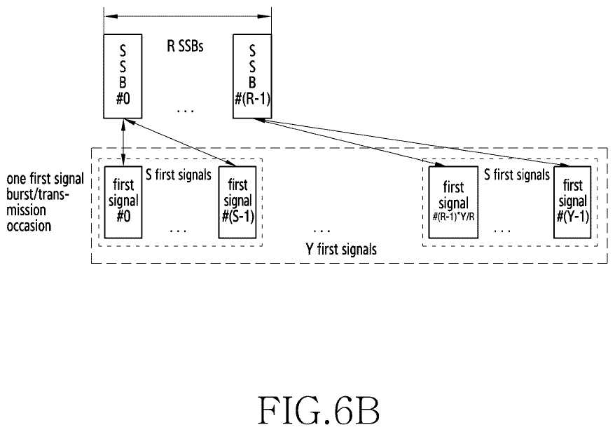

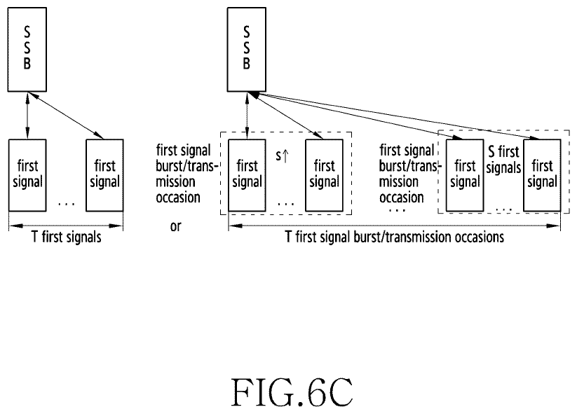

A UE may use the first signal to reduce power overhead. The UE acquires configuration information for the first signal by receiving a radio resource control RRC message and/or a higher layer parameter. If the configuration information for the first signal is provided by the RRC message and/or the higher layer parameter, the UE supporting the first signal may monitor the first signal using the first signal configuration parameter configured in the RRC message and/or the higher layer parameter. Optionally, in RRC INACTIVE and/or IDLE state, the first signal may be configured in an SIB and/or MIB and/or SDT. Optionally, in the RRC IDLE state, the first signal may be configured in the higher layer parameter. The configuration information for the first signal or the first signal resource or a set of first signal resources includes a combination of one or more of:
a number of consecutive paging occasions (POs) associated with each first signal to indicate a number of POs that the UE is awakened to monitor when the UE monitors the associated first signal;
an information bit length (payload size), optionally, to indicate a cell index and/or UE or UE group index;
whether the first signal can be monitored across cells or the first signal being monitored only in the present cell. The UE may monitor the first signal in the camped cell, when a value of whether the first signal can be monitored across cells is “TRUE” or “ON” or the monitoring of the first signal only in the present cell is “FALSE” or “OFF” or not configured in the RRC message; and the UE only monitors the first signal within a cell in which the RRC link is released if the UE has recently received a release RRC link message without a non-last cell update, when the value of whether the first signal can be monitored across cells is “FALSE” or “OFF” or the monitoring of the first signal only in the present cell is “TRUE” or “ON”;
a modulation scheme including at least one of: OOK, FSK, OFDMA. When the UE reports one or more UE supported modulation schemes, i.e. UE capabilities, it is used to indicate the modulation scheme for the enabled first signal, avoiding the problem of inconsistent understanding of the modulation scheme of the first signal by the base station and the UE.
a bandwidth that is a bandwidth of a first signal and/or a bandwidth of a guard band. The bandwidth of the first signal may be indicated as m PRBs, where m may be a parameter value (pre) configured or predefined by a base station device and/or reported by the UE in terms of its own processing capability. m is a natural number, and m is greater than or equal to 1. Optionally, m=1.
frequency position, optionally the same frequency domain position as the PO; optionally, the frequency domain position is configured in CORESETO, which may be determined by a frequency domain start point of CORESETO plus a predefined or preconfigured offset, as shown in FIG. 5A; optionally, for paging in an initial downlink BWP, the frequency domain position is configured in the initial downlink BWP, the frequency domain position can be determined by the frequency domain start point of the initial downlink BWP or pointA plus a predefined or preconfigured offset as in FIG. 5B; optionally, for paging in a DL BWP other than the initial downlink BWP, the frequency domain position is configured in the DL BWP other than the initial downlink BWP, the frequency domain position can be determined by the frequency domain start point of the configured DL BWP or pointA plus a predefined or preconfigured offset;
a cycle of the first signal, which may have a value of at least one of: 160 ms, 320 ms, 480 ms, 960 ms. Optionally, the cycle is the same as a cycle of the PO; optionally, a cycle of LP-SS may be configured according to a cycle of SSB, and may be configured to be W times the cycle of SSB, where W is a real number greater than 0, and W may be less than 1, optionally W=1;
a time domain start point or end point for waking up the UE, indicating whether the UE monitors the first signal of the corresponding PO, which is related to the start point of the PO, and optionally within a time interval of a predefined or preconfigured value before the start point of the PO.
operation mode information, which may include at least one of: in-band transmission, guard band transmission, individual band transmission. If the first signal is configured as an in-band transmission, the UE may be indicated that the first signal and the NR signal and/or channel share the same physical cell index, or that the first signal and the NR signal and/or channel share different physical cell indexes. When the first signal and the NR signal and/or channel share the same physical cell index, the UE assumes that the number of first signal ports and SSB ports are the same.
an average number of first signals for cell measurement. If the average number of first signals for cell measurement is not configured, the highest beam measurement quantity value is used as the cell measurement quantity. Otherwise, the cell measurement quantity is a linear average of highest beam measurement power values with a number of up to the average number of first signals for cell measurement.
an indicated measurement quantity that the UE is requested to report, an optional measurement quantity may include at least one of: RSSI, RSRP, SINR, RSRQ. The UE performs measurements based on the first signal according to the indicated measurement quantity requested to be reported, and reports one or more measurement results.
a subcarrier spacing of the first signal, optionally equal to the subcarrier spacing of the initial downlink BWP or CORESETO;
an antenna port for the first signal; the method of configuring the antenna port for the first signal may include a combination of one or more of:
   the UE assuming that all resource elements used for the first signal transmission within a given time unit or an OFDM symbol duration of a (pre) configured or predefined sequence length use the same antenna port;
   if there is no explicit signaling indication of the antenna port configuration for the first signal, and/or if only one TRS or LP-SS or SSB port is configured by a base station, the UE may assume that transmissions of all the time units in which the first signal is located uses the same antenna port;
   if there is no explicit signaling indication of the antenna port configuration for the first signal, and/or if more than one TRS or LP-SS or SSB ports are configured by a base station, the UE may assume that the same antenna port is used in T consecutive time units starting from the first time unit of the first signal transmission. The association relation of the first signal with the more than one configured TRS or LP-SS or SSB ports are determined by a quasi co-location (QCL) relation of the first signal.
   if the first signal is configured with only one antenna port, the UE may assume that transmissions of all the time units in which the first signal is located use the same antenna port;
   if the first signal is configured with more than one antenna ports, the UE may assume that the same antenna port is used in T consecutive time units starting from the first time unit of the first signal transmission. The association relation of the first signal with the more than one configured TRS or LP-SS or SSB ports are determined by a quasi co-location (QCL) relation of the first signal.
   optionally, the time unit is a downlink time unit;
   T may be a parameter value (pre) configured or predefined by the base station device and/or reported by the UE in terms of its own processing capability. T is a natural number, and T is greater than or equal to 1.
a power control offset with respect to the SSB, i.e., a ratio of the Energy per resource element of the first signal to the SSB EPRE, which may have a value including at least one of: −3 dB, 0 dB, 3 dB, 6 dB. The value is a multiple of 3, mainly because a power boost of 3 dB is equivalent to a change of the power to 2 times the original power, and a power reduction of 3 dB is equivalent to a change of the power to ½ of the original power. If the power control offset with respect to the SSB is not provided or configured, the UE assumes that the value of the offset is 0 dB, i.e. the EPRE of the first signal is equal to the EPRE of the SSB. The offset is applicable to the first signal resource or all resources in a set of resources.
a method of determining the quasi co-location (QCL) relation of the first signal, which may include a combination of one or more of:
   no QCL relation
   being given by an SSB index configured in higher layer parameters or RRC or SIB, the configured QCL relation of the first signal is applied to the first signal resource or all resources in the set of resources, as shown in FIG. 6A.
   being given by an SSB index corresponding to CORESET0, which is applied to the first signal resource or all resources in the set of resources.
   the UE being provided or configured that R SSBs indexes are associated to one first signal that has a QCL relation with the R SSBs and may be one first signal burst or first signal transmission occasion, the R being a preconfigured or predefined parameter value. This is applicable to the case where the first signal is a coarse beam and the SSB is a fine beam.
   the UE being provided or configured that an SSB index is associated to T consecutive and/or valid first signals, wherein the first signals may be first signals or first signal bursts or first signal transmission occasions, and the T consecutive and/or valid first signals have a QCL relation with the one SSB, T being a preconfigured or predefined parameter value. Optionally, this is applicable to the case where the first signal is a coarse beam and the SSB is a fine beam.
   optionally, the UE being provided or configured that each first signal occasion/burst is associated to preambles of S first signals per SSB index, wherein the preambles of S first signals with consecutive indexes associated with SSB index n (n=0, . . . , R−1) within each first signal burst or occasion start from preamble index n*Y/R, as shown in FIG. 6B. Y is a predefined or preconfigured total number of preambles of the first signals, which is a preconfigured or predefined parameter value and is an integer multiple of R, S=Y/R−1.
   optionally, the UE being provided or configured that each first signal occasion/burst is associated to preambles of S first signals per SSB index, wherein more than one first signals are included in the first signal burst or first signal transmission occasion, and the preambles of S first signals with consecutive indexes associated with one SSB index within each first signal burst or occasion start from preamble index 0, as shown in FIG. 6C.
   optionally, the UE being provided or configured that each first signal occasion/burst is associated to preambles of W first signals per SSB index, wherein the preamble index of the first signal associated with SSB index i (i=0, . . . , R−1) within each first signal burst or occasion is n*Y/R+i (n=0, . . . , R−1).
a QCL type of the first signal, which may include a combination of one or more of:
   the UE expecting to be indicated that the first signal has a QCL relation of “typeA” or “typeB” or “typeC” with the SSB;
   the UE expecting to be indicated that the first signal has a QCL of “typeD” with the SSB, optionally the SSB may have a physical cell ID (PCI) different from the PCI of the serving cell. The UE may assume that the center frequency, SCS, SFN offset are the same for SSB from the serving cell and SSB with PCI different from the serving cell.

The pseudorandom sequence generator generating the first signal should be initialized at each OFDM symbol or each slot. The mapping of the sequence of the first signal may include a combination of one or more of:
the UE determining that the first signal is resource mapped and/or transmitted in-band and/or on guard band or separate band by receiving RRC parameter and/or higher layer parameter indication. On the indicated carrier, the first signal sequence is mapped onto time units in the actual first signal duration, the first signal sequence should be mapped onto resource elements (k, l), starting from an element value with a number of 0 of the sequence, on the allocated 12*m subcarriers, first arranged in an ascending order of subcarrier indexes k=0, 1, . . . , 12*m−1, and then the first signal is transmitted in each time unit with OFDM indexes l=2, 3, . . . , or l=4, 5, . . . , n*14−1; m is the number of PRBs to which the first signal sequence is mapped, and n is the number of slots to which the first signal sequence is mapped.
sequence mapping with n slots as a basic unit, and repeating/extending the mapping of the first signal over more than one slots to support a larger coverage. Optionally, n=1.
sequence mapping with m physical resource blocks as a basic unit, and repeating/extending the mapping of the first signal at more than one physical resource blocks to increase the transmission power of the first signal to reach a coverage as the same as, or that can match, a coverage of the PDCCH for paging and/or the PUSCH for Message 3.
on a frequency domain unit, mapping the resource elements of the first signal every L subcarriers to achieve the effect of repetitive transmission on the time domain to enlarge the coverage of the first signal. Optionally, L=1.
n, L may be parameter values (pre) configured or predefined by the base station device and/or reported by the UE in terms of its processing capabilities. n and L are natural numbers, and n and L are greater than or equal to 1.

The UE can increase the coverage of the first signal by performing a method of receiving-end frequency hopping. The method for the UE to perform receiving-end frequency hopping may include a combination of one or more of:
on a frequency domain unit, the UE being configured to perform receiving-end frequency domain hopping based on a resource or time unit of one first signal, wherein the resource of the one first signal can be the n time units of sequence mapping of the first signal, and/or m physical resource blocks.
depending on the maximum duration of the first signal configured by higher layer signaling or RRC or SIB, the UE expecting to receive all hops of the first signal using frequency domain hopping within the maximum duration of the first signal.
optionally, the UE not expecting to receive the first signal for RRM measurement except for the first signal for wake-up using frequency domain frequency hopping when transmission in the maximum duration of the first signal for RRM measurement or the repetition of the first signal in time domain overlaps with that of the first signal for wake-up in the maximum duration of the first signal.

Behavior of UE monitoring/not being able to monitor first signal for wake-up is provided.

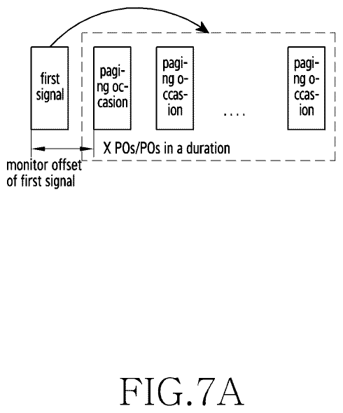

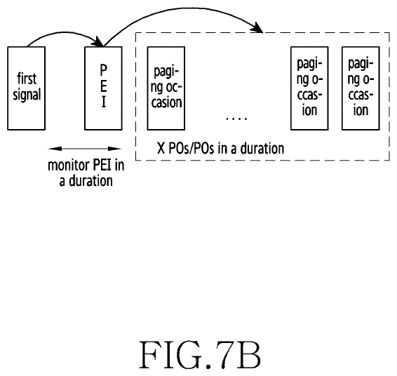

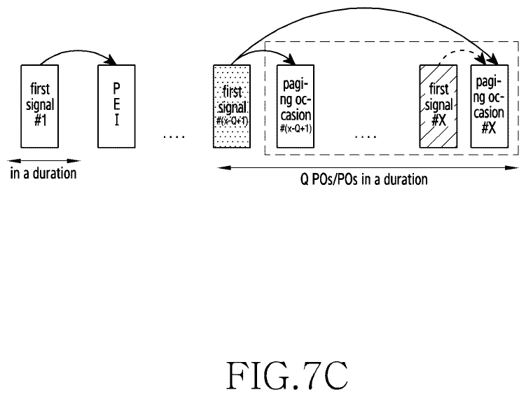

The UE assumes that no more than one first signal sequence is transmitted on each first signal resource in a given time. The behavior of the UE monitoring the first signal for wake-up may include a combination of one or more of:
if the UE detects the first signal, optionally, if extended DRX is used and the UE detects the first signal, the UE is awakened to monitor the subsequent X PO(s) or PO(s) within a predefined or preconfigured duration, and/or until a UE-specific paging message is received, and/or whatever earlier.
optionally, as shown in FIG. 7A, the subsequent X PO(s) or PO(s) within a predefined or preconfigured duration may be mapped to 1 first signal, i.e. the UE monitors the first signal within a predefined or preconfigured time unit before the start point of the X PO(s) or the predefined or preconfigured duration, if the UE detects the first signal, the UE is awakened to monitor the subsequent X PO(s) or PO(s) within a predefined or preconfigured duration, and/or until a UE-specific paging message is received, and/or whatever earlier.
optionally, as shown in FIG. 7B, the first signal may carry 1 bit indication information indicating whether the UE monitors PEI within a predefined or preconfigured duration or whether the UE is awakened to monitor the subsequent X PO(s) or PO(s) within a predefined or preconfigured duration. Optionally, the UE does not monitor the SSB within the duration, which may reduce the power overhead incurred by monitoring the SSB;
optionally, the subsequent X PO(s) may be the subsequent X consecutive PO(s) mapped to X first signals, i.e. the UE monitors the first signal within a predefined or preconfigured time unit before the start point of each PO. When the UE detects the first signal, the UE is awakened to monitor the subsequent Q consecutive PO(s) or PO(s) within a predefined or preconfigured duration, and/or until a UE-specific paging message is received, and/or whatever is earlier. When the UE monitors the subsequent Q PO(s), the UE does not monitor the first signal associated with it, as shown in FIG. 7C. Q is less than X.
optionally, the subsequent X PO(s) are within a periodic Paging Time Window (PTW) configured for the UE.
X, Q may be parameter values (pre) configured or predefined by the base station device and/or reported by the UE in terms of its own processing capabilities. X and Q are natural numbers, and X and Q are greater than or equal to 1.

If the UE cannot monitor the first signal corresponding to its PO, e.g., during cell reselection, the UE is awakened to monitor each or associated PO. Optionally, if the UE cannot monitor the first signal corresponding to its PO, e.g., during cell reselection, the UE is awakened to monitor each or associated PO until the start of the next first signal or until the end of the PTW, whatever is earlier.

RRM Measurement is provided.

In a multi-beam operation, the UE assumes that the same first signal is repeatedly transmitted on all transmitting beams, and the beam used for receiving the first signal depends on the UE implementation.

The transmit power of the first signal in downlink is defined as a linear average over the power contributions (in [watts]) of the resource elements carrying the configured first signal within the operating system bandwidth. The EPRE of the first signal in downlink may be derived from the transmit power of SSB and the configured power control offset with respect to the SSB. The RSRP measurement result of the first signal should be greater than or equal to a predefined or preconfigured threshold value.

When the first condition is satisfied, the UE may perform an RRM measurement based on the configured first signal, otherwise, the UE performs the RRM measurement based on the SSB. The RRM measurement may be an RRM measurement for a serving cell and/or a neighboring cell and/or a camped cell. The first condition may include a combination of one or more of:
being in an RRC INACTIVE and/or IDLE state;
if a reference cell selection RX level value (Srxlev) of the serving cell minus Srxlev calculated based on the RSRP of the first signal is less than or equal to T1; after cell selection or cell reselection to a new cell, or if the Srxlev calculated based on the RSRP of the first signal is greater than the reference Srxlev of the serving cell, the UE shall set the reference Srxlev of the serving cell to the Srxlev calculated based on the RSRP of the first signal.
if Z consecutive RSRPs based on the first signal are greater than or not less than (which, herein, may be used interchangeably with being greater than or equal to) T2 and/or V consecutive RSRPs based on the first signal are greater than or not less than T3, the UE performs the RRM measurement based on the first signal. If Z consecutive RSRPs based on the first signal are less than T2 and/or V consecutive RSRQs based on the first signal are less than T3, the UE performs the RRM measurement based on the SSB. Z, V are preconfigured or predefined values, optionally, Z=V. At this time, since the UE is at the cell edge, a coverage of the first signal is insufficient, and the RRM measurement based on the first signal is inaccurate, and thus, the RRM measurement is performed using the SSB with a larger coverage;
if the RSRP of the first signal is greater than or not less than T4 and/or the RSRQ of the first signal is greater than or not less than T5, or if the Srxlev calculated based on the RSRP of the first signal is greater than or not less than T6 and/or a cell selection quality value (Squal) calculated based on the RSRQ of the first signal is greater than or not less than T7, the UE performs the RRM measurement based on the first signal. If the RSRP of the first signal is less than or not greater than (which, herein, may be used interchangeably with being less than or equal to) T4 and/or the RSRQ of the first signal is less than or not greater than T5, or if the Srxlev calculated based on the RSRP of the first signal is less than or not greater than T6 and/or the Squal calculated based on the RSRQ of the first signal is less than or not greater than T7, the UE performs the RRM measurement based on the SSB. At this time, since the UE is at the cell edge, the coverage of the first signal is insufficient, and the RRM measurement based on the first signal is inaccurate, and thus, the RRM measurement is performed using the SSB with a larger coverage;
within a preconfigured or predefined time unit, when a change range of one and/or more than one RSRPs of the first signal is less than or equal to T8 and/or a change range of one and/or more than one RSRQs of the first signal is less than or equal to T9, or a change range of the Srxlev calculated based on the RSRP of the first signal is less than or equal to T10 and/or a change range of the Squal calculated based on the RSRQ of the first signal is less than or equal to T11, the UE performs the RRM measurement based on the first signal;
when the RSRP of the SSB is greater than or not less than T12 and/or the RSRQ of the SSB is greater than or not less than T13, or when the Srxlev calculated based on the RSRP of the SSB is greater than or not less than T14 and/or the Squal calculated based on the RSRQ of the SSB is greater than or not less than T15, the UE may perform the RRM measurement based on the first signal. Otherwise, the UE performs the RRM measurement based on the SSB;
within a preconfigured or predefined time unit, when a change range of the RSRP of the SSB is less than or equal to T16 and/or a change range of the RSRQ of the SSB is less than or equal to T17, or when a change range of the Srxlev calculated based on the RSRP of the SSB is less than or equal to T18 and/or a change range of the Squal calculated based on the RSRQ of the SSB is less than or equal to T19, the UE may perform the RRM measurement based on the first signal. Otherwise, the UE performs the RRM measurement based on the SSB;
T1, T2, T3, T4, T5, T6, T7, T8, T9, T10, T11, T12, T13, T14, T15, T16, T17, T18, T19 are predefined or (pre) configured threshold values, which are all real numbers.

Conditions for the UE to perform the RRM measurement based on the SSB may include a combination of one or more of:
if the first signal is not received for more than D time units, after D time units, the UE performs the RRM measurement based on the SSB. D is a parameter value predefined or (pre) configured by a base station, and D is a real number greater than 0. Optionally, no reception of the first signal for more than D time units is due to the first signal being dropped or delayed for transmission during D time units.
if a change range or difference of an RSRP of a first signal of the neighboring cell and an RSRP of a first signal of the serving cell is greater than or not less than T20 and/or a change range or difference of an RSRQ of the first signal of the neighboring cell and an RSRQ of the first signal of the serving cell is greater than or not less than T21, or a change range of a Srxlev calculated based on the RSRP of the first signal is greater than or not less than T22 and/or a Squal calculated based on the RSRQ of the first signal is greater than or not less than T23, the UE performs the RRM measurement based on the SSB or the UE performs cell selection and/or cell reselection. Since the UE cannot determine whether RRM measurement results of the neighboring cell and serving cell are excessively different due to the measurement results based on the first signal being inaccurate or due to the coverage of the first signal being limited, the UE is awakened to perform the RRM measurement using the SSB.
if the UE cannot monitor the first signal, e.g. during cell reselection, the UE is awakened to use the SSB for the RRM measurement. Optionally, if the UE cannot monitor the first signal, e.g. during cell reselection, the UE is awakened to use the SSB for the RRM measurement until the start of the next first signal (e.g. LP-SS or LP-SS burst) or until the end of the PTW, whatever is earlier.
T20, T21, T22, T23 are predefined or (pre) configured threshold values, which are all real numbers.

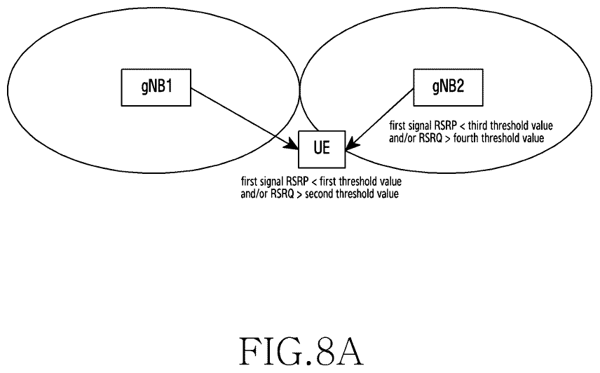

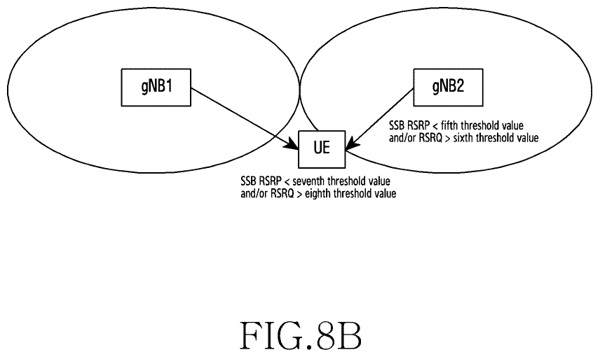

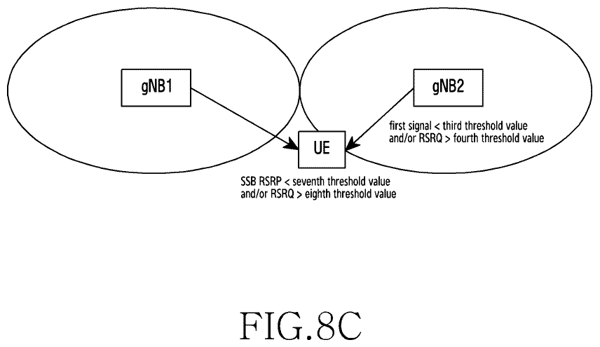

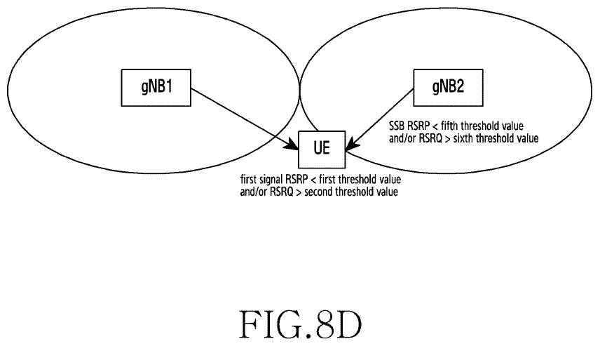

Conditions for the UE to perform the cell selection and/or cell reselection may include a combination of one or more of:
if the RRM measurement result based on the first signal satisfies a cell reselection principle, i.e., the RSRP of the first signal is less than or not greater than a first threshold value and/or the RSRQ of the first signal is less than or not greater than a second threshold value, or the Srxlev calculated based on the RSRP of the first signal is less than or not greater than the first threshold value and/or the Squal calculated based on the RSRQ of the first signal is less than or not greater than the second threshold value, the UE performs the cell selection and/or cell reselection. Otherwise, the UE performs the RRM measurement for the serving cell and/or the neighboring cell based on the first signal, as shown in FIG. 8A. The UE performing the RRM measurement for the serving cell and the neighboring cell based on the first signal is applicable to a case where the first signal and the SSB have the same coverage. The UE performing the RRM measurement for the serving cell based on the first signal is applicable to a case where the first signal and the SSB have the same coverage and the UE capability does not support the RRM measurement for the neighboring cell based on the first signal.
if there is one non-serving cell for a predefined or preconfigured duration, the RSRP based on the first signal is greater than or not less than a third threshold value and/or the RSRQ based on the first signal is greater than or not less than a fourth threshold value, or the Srxlev calculated based on the RSRP of the first signal is greater than or not less than the third threshold value and/or the Squal calculated based on the RSRQ of the first signal is greater than or not less than the fourth threshold value, the UE may camp on the current cell, as shown in FIG. 8A. If there are multiple cells for a predefined or preconfigured duration, the RSRP based on the first signal is greater than or not less than the third threshold value and/or the RSRQ based on the first signal is greater than or not less than the fourth threshold value, or the Srxlev calculated based on the RSRP of the first signal is greater than or not less than the third threshold value and/or the Squal calculated based on the RSRQ of the first signal is greater than or not less than the fourth threshold value, the UE selects a cell on a frequency with the highest priority.
if the RRM measurement result based on the SSB satisfies the cell reselection principle, i.e., the RSRP of the SSB is less than or not greater than a seventh threshold value and/or the RSRQ of the SSB is less than or not greater than an eighth threshold value, or the Srxlev calculated based on the RSRP of the SSB is less than or not greater than the seventh threshold value and/or the Squal calculated based on the RSRQ of the SSB is less than or not greater than the eighth threshold value, the UE performs the cell selection and/or cell reselection, as shown in FIG. 8B.
if there is one non-serving cell for a predefined or preconfigured duration, the RSRP based on the SSB is greater than or not less than a fifth threshold value and/or the RSRQ based on the SSB is greater than or not less than a sixth threshold value, or the Srxlev calculated based on the RSRP of the SSB is greater than or not less than the fifth threshold value and/or the Squal calculated based on the RSRQ of the SSB is greater than or not less than the sixth threshold value, the UE may camp on the current cell, as shown in FIG. 8B. If there are multiple cells for a predefined or preconfigured duration, the RSRP based on the SSB is greater than or not less than the fifth threshold value and/or the RSRQ based on the SSB is greater than or not less than the sixth threshold value, or the Srxlev calculated based on the RSRP of the SSB is greater than or not less than the fifth threshold value and/or the Squal calculated based on the RSRQ of the SSB is greater than or not less than the sixth threshold value, the UE selects a cell on a frequency with the highest priority.
optionally, as shown in FIG. 8C, the UE may determine whether the cell reselection principle is satisfied based on the SSB and/or whether it can camp on a cell based on the first signal.
optionally, as shown in FIG. 8D, the UE may determine whether the cell reselection principle is satisfied based on the first signal and/or whether it can camp on a cell based on the SSB.
when the first condition is not satisfied and/or if the RRM measurement result based on the SSB does not satisfy the cell reselection principle, i.e., the RSRP of the SSB is greater than or not less than the seventh threshold value and/or the RSRQ of the SSB is greater than or not less than the eighth threshold value, or the Srxlev calculated based on the RSRP of the SSB is greater than or not less than the seventh threshold value and/or the Squal calculated based on the RSRQ of the SSB is greater than or not less than the eighth threshold value, the UE performs the RRM measurement for the serving cell and non-serving cell based on the SSB.
when the first condition is satisfied and/or if the RRM measurement result based on the SSB does not satisfy the cell reselection principle, i.e., the RSRP of the SSB is greater than or not less than the seventh threshold value and/or the RSRQ of the SSB is greater than or not less than the eighth threshold value, or the Srxlev calculated based on the RSRP of the SSB is greater than or not less than the seventh threshold value and/or the Squal calculated based on the RSRQ of the SSB is greater than or not less than the eighth threshold value, the UE does not perform the RRM measurement for the non-serving cell.
optionally, the seventh threshold value may be equal to the first threshold value and the eighth threshold value may be equal to the second threshold value;
optionally, the fifth threshold value may be equal to the third threshold value and the sixth threshold value may be equal to the fourth threshold value;
The first threshold value, the second threshold value, the third threshold value, the fourth threshold value, the fifth threshold value, the sixth threshold value, the seventh threshold value, the eighth threshold value are preconfigured or predefined threshold values, which are all real numbers.

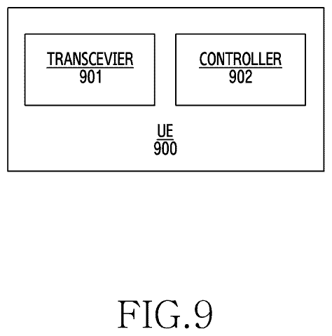

FIG. 9 illustrates a block diagram of a configuration of a user equipment (UE) 900 according to various embodiments of the present disclosure.

Referring to FIG. 9, a UE 900 according to various embodiments of the present disclosure may include a transceiver 901 and a controller 902. For example, the transceiver 901 may be configured to transmit and receive signals. For example, the controller 902 may be coupled to the transceiver 901 and configured to perform the aforementioned methods.

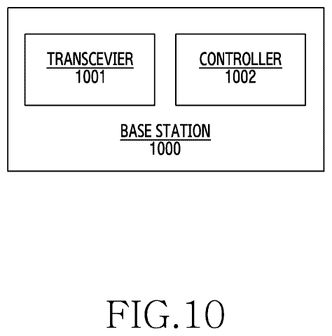

FIG. 10 illustrates a block diagram of a configuration of a user equipment (UE) 1000 according to various embodiments of the present disclosure.

Referring to FIG. 10, a UE 1000 according to various embodiments of the present disclosure may include a transceiver 1001 and a controller 1002. For example, the transceiver 1001 may be configured to transmit and receive signals. For example, the controller 1002 may be coupled to the transceiver 1001 and configured to perform the aforementioned methods.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the invention of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. An exemplary storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

The above description is only an exemplary implementation of the present invention, and is not intended to limit the scope of protection of the present invention, which is determined by the appended claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving configuration information for a first signal;
performing a radio resource management (RRM) measurement based on the first signal in a case that a reference signal received power or a reference signal received quality of the first signal is determined to satisfy a first condition based on the configuration information; and
performing the RRM measurement based on a synchronization signal and physical broadcast channel block (SSB) in a case that the reference signal received power or the reference signal received quality of the first signal is determined not to satisfy the first condition based on the configuration information.

2. The method of claim 1, further comprising:
performing the RRM measurement based on the SSB in a case that a second condition is determined to be satisfied.

3. The method of claim 2, further comprising:
performing the RRM measurement based on the first signal in a case that the second condition is determined not to be satisfied.

4. The method of claim 1, wherein the first condition comprises at least one of:
a difference between a reference cell selection RX level value for a serving cell of the UE and a cell selection RX level value calculated based on a reference signal received power of the first signal being less than or equal to a first threshold value,
more than one consecutive reference signal received powers of the first signal being greater than or equal to a second threshold value,
more than one consecutive reference signal received qualities of consecutive first signals being greater than or equal to a third threshold value,
the reference signal received power of the first signal being greater than or equal to a fourth threshold value,
the reference signal received quality of the first signal being greater than or equal to a fifth threshold value,
the cell selection RX level value calculated based on the reference signal received power of the first signal being greater than or equal to a sixth threshold value,
a cell selection quality value calculated based on the reference signal received quality of the first signal being greater than or equal to a seventh threshold value,
a change range of one or more reference signal received powers of the first signal being less than or equal to an eighth threshold value,
a change range of one or more reference signal received qualities of the first signal being less than or equal to a ninth threshold value,
a change range of the cell selection RX level value calculated based on the reference signal received power of the first signal being less than or equal to a tenth threshold value,
a change range of the cell selection quality value calculated based on the reference signal received quality of the first signal being less than or equal to an eleventh threshold value,
a reference signal received power based on the SSB being greater than or equal to a twelfth threshold value,
a reference signal received quality based on the SSB being greater than or equal to a thirteenth threshold value,
a cell selection RX level value calculated based on the reference signal received power of the SSB being greater than or equal to a fourteenth threshold value,
a cell selection quality value calculated based on the reference signal received quality of the SSB being greater than or equal to a fifteenth threshold value,
a change range of the reference signal received power based on the SSB being less than or equal to a sixteenth threshold value,
a change range of the reference signal received quality based on the SSB being less than or equal to a seventeenth threshold value,
a change range of the cell selection RX level value calculated based on the reference signal received power of the SSB being less than or equal to an eighteenth threshold value, and
the cell selection quality value calculated based on the reference signal received quality of the SSB being less than or equal to a nineteenth threshold value.

5. The method of claim 3, wherein the second condition comprises at least one of:
the first signal not being received for more than a predefined or preconfigured time unit,
a change range or a difference between a reference signal received power of a first signal of a neighboring cell of the UE and a reference signal received power of a first signal of a serving cell of the UE being greater than or equal to a twentieth threshold value,
a change range or a difference between the reference signal received quality of the first signal of the neighboring cell of the UE and the reference signal received quality of the first signal of the serving cell being greater than or equal to a twenty-first threshold value,
a change range of a cell selection RX level value calculated based on the reference signal received power of the first signal being greater than or equal to a twenty-second threshold value,
a cell selection quality value calculated based on the reference signal received quality of the first signal being greater than or equal to a twenty-third threshold value, and
the UE not monitoring the first signal.

6. The method of claim 1, further comprising determining whether to perform cell selection or cell reselection according to the reference signal received power or the reference signal received quality of the first signal or the SSB and one or more predefined or preconfigured threshold values, wherein determining whether to perform cell selection or cell reselection comprises at least one of:
in a case that the reference signal received power of the first signal is less than or equal to a first threshold value of the one or more predefined or preconfigured threshold values or the reference signal received quality is less than or equal to a second threshold value of the one or more predefined or preconfigured threshold values, or a cell selection RX level value calculated based on the reference signal received power of the first signal is less than or equal to the first threshold value of the one or more predefined or preconfigured threshold values or a cell selection quality value calculated based on the reference signal received quality of the first signal is less than or equal to the second threshold value of the one or more predefined or preconfigured threshold values, performing the cell selection or cell reselection;
in a case that the reference signal received power of the first signal being greater than or equal to a third threshold value of the one or more predefined or preconfigured threshold values or the reference signal received quality of the first signal being greater than or equal to a fourth threshold value of the one or more predefined or preconfigured threshold values, or the cell selection RX level value calculated based on the reference signal received power of the first signal being greater than or equal to the third threshold value of the one or more predefined or preconfigured threshold values or the cell selection quality value calculated based on the reference signal received quality of the first signal being greater than or equal to the fourth threshold value of the one or more predefined or preconfigured threshold values, camping, by the UE, on a current cell;
in a case that a reference signal received power of the SSB is less than or equal to a seventh threshold value of the one or more predefined or preconfigured threshold values or a reference signal received quality of the SSB is less than or equal to an eighth threshold value of the one or more predefined or preconfigured threshold values, or a cell selection RX level value calculated based on the reference signal received power of the SSB is less than or equal to the seventh threshold value of the one or more predefined or preconfigured threshold values or a cell selection quality value calculated based on the reference signal received quality of the SSB is less than or equal to the eighth threshold value of the one or more predefined or preconfigured threshold values, performing the cell selection or cell reselection; and
in a case that the reference signal received power of the SSB is greater than or equal to a fifth threshold value of the one or more predefined or preconfigured threshold values or the reference signal received quality is greater than or equal to a sixth threshold value of the one or more predefined or preconfigured threshold values, or a cell selection RX level value calculated based on the reference signal received power of the SSB is greater than or equal to the fifth threshold value of the one or more predefined or preconfigured threshold values or a cell selection quality value calculated based on the reference signal received quality of the SSB is greater than or equal to the sixth threshold value of the one or more predefined or preconfigured threshold values, camping, by the UE, on the current cell.

7. The method of claim 1, wherein the first signal is used to indicate whether to monitor a corresponding paging occasion (PO).

8. The method of claim 7, further comprising monitoring the first signal, wherein monitoring the first signal comprises at least one of:
monitoring the first signal within a predefined or preconfigured time unit before a start point of a number of POs or a predefined or preconfigured duration,
monitoring the first signal within a predefined or preconfigured time unit before a start point of each PO.

9. The method of claim 8, wherein monitoring the first signal within a predefined or preconfigured time unit before a start point of each PO comprises:
when the UE detects the first signal, waking up to monitor a number of subsequent POs, or until a UE-specific paging message is received.

10. The method of claim 9, further comprising:
when the UE monitors the number of subsequent POs, not monitoring the first signal associated with the PO.

11. The method of claim 8, further comprising:
if the UE is unable to monitor the first signal, monitoring, by the UE, each or associated paging occasion (PO).

12. The method of claim 11, wherein an end point where each or associated paging occasion (PO) is monitored comprises a start of a next first signal or an end point of a paging time window.

13. The method of claim 1, wherein the configuration information further comprises at least one of:
a frequency domain position of the first signal,
a quasi co-location (QCL) relation of the first signal,
a power control offset of the first signal with respect to the SSB, and
an antenna port of the first signal.

14. The method of claim 13, wherein the frequency domain position of the first signal comprises at least one of:
being the same as a frequency domain position where a corresponding PO is located,
being configured in a CORESET0,
being configured in an initial downlink bandwidth part (BWP) for paging in the initial downlink BWP, and
being configured in a downlink BWP other than the initial downlink BWP for paging in the downlink BWP other than the initial downlink BWP.

15. The method of claim 13, wherein a method of determining the QCL relation of the first signal comprises at least one of:
the first signal not having the QCL relation if the configuration information does not include the QCL relation of the first signal,
determining based on an SSB index configured in a higher layer parameter or RRC or SIB,
determining based on the SSB index corresponding to a CORESET0,
the first signal having the QCL relation with a number of SSBs, if it is provided or configured that the number of SSBs indexes are associated to one first signal, and
the first signal having the QCL relation with one SSB, if it is provided or configured that an SSB index is associated to a number of consecutive or valid first signals.

16. The method of claim 13, wherein if the power control offset of the first signal with respect to the SSB is not provided or configured, a value of the offset is 0 dB.

17. The method of claim 13, wherein a method for configuring the antenna port of the first signal comprises at least one of:
a same antenna port being used by all resource elements used for a first signal transmission within a predefined or preconfigured time unit or an OFDM symbol duration of a predefined or preconfigured sequence length,
if there is no explicit signaling indication of an antenna port configuration for the first signal, or if only one tracking reference signal (TRS) or low power synchronization signal (LP-SS) or SSB port is configured, a same antenna port being used by transmissions of time units where all first signals are located,
if there is no explicit signaling indication of the antenna port configuration for the first signal, or if more than one TRS or LP-SS or SSB ports are configured by a base station, a same antenna port being used in a number of consecutive time units starting from the first time unit for the first signal transmission, wherein an association relation of the first signal with the more than one configured TRS or LP-SS or SSB ports are determined by the QCL relation of the first signal,
if the first signal is configured with only one antenna port, a same antenna port being used by the transmissions of the time units where all first signals are located, and
if the first signal is configured with more than one antenna ports, a same antenna port being used in the number of consecutive time units starting from the first time unit for the first signal transmission, wherein the association relation of the first signal with the more than one configured TRS or LP-SS or SSB ports are determined by the QCL relation of the first signal.

18. A method performed by a base station in a wireless communication system, comprising:
transmitting, to a user equipment (UE), configuration information for a first signal, wherein the configuration information is used to determine whether a reference signal received power or a reference signal received quality of the first signal satisfies a first condition for performing a radio resource management (RRM) measurement based on the first signal; and
receiving a result of the RRM measurement from the UE.

19. A user equipment (UE) in a wireless communication system, the UE comprising:
a transceiver; and
a controller coupled with the transceiver and configured to:
receive configuration information for a first signal,
performing a radio resource management (RRM) measurement based on the first signal in a case that a reference signal received power or a reference signal received quality of the first signal is determined to satisfy a first condition based on the configuration information, and
performing the RRM measurement based on a synchronization signal and physical broadcast channel block (SSB) in a case that the reference signal received power or the reference signal received quality of the first signal is determined not to satisfy the first condition based on the configuration information.

20. A base station in a wireless communication system, the base station comprising:
a transceiver; and
a controller coupled with the transceiver and configured to:
transmit, to a user equipment (UE), configuration information for a first signal, wherein the configuration information is used to determine whether a reference signal received power or a reference signal received quality of the first signal satisfies a first condition for performing a radio resource management (RRM) measurement based on the first signal, and
receive a result of the RRM measurement from the UE.
